(19) United States
(12) Patent Application Publication
(10) Pub. No.: US 2026/0148533 A1
(43) Pub. Date: May 28, 2026

(54) SUBJECT RE-IDENTIFICATION USING SEMANTIC ATTRIBUTE RECOGNITION

(71) Applicant: NVIDIA Corporation, Santa Clara, CA (US)

(72) Inventors: Sameer Satish Pusegainkar, San Francisco, CA (US); Zheng Tang, Bothell, WA (US); Yizhou Wang, Milpitas, CA (US); Sujit Biswas, Newark, CA (US); Yuxing Wang, Cupertino, CA (US)

(21) Appl. No.: 18/960,754

(22) Filed: Nov. 26, 2024

(51) Int. Cl. G06V 10/774; G06V 10/82; G06V 20/70

(52) U.S. Cl. CPC G06V 10/7747; G06V 10/82; G06V 20/70

(57) ABSTRACT

A method includes generating semantic data corresponding to appearance features of a person within a first image. One or more models and the semantic data are used to generate attribute features of the person. The one or more models, the semantic data, and the attribute features are used to generate an embedding. The one or more models and the embedding are used to identify the person within a second image.

### TECHNICAL FIELD

At least one embodiment pertains to Person Search and Tracking (PST) technologies, such as Person re-identification (ReID) or Pedestrian Attribute Recognition (PAR).

### BACKGROUND

Person searching and tracking (PST) technology is used in various industries and applications, such as in surveillance, security, and analytics by enabling the identification and monitoring of individuals across multiple camera views. Traditional methods often rely on embeddings—vector representations of visual features extracted by neural networks—to match person images from different cameras. However, embeddings can sometimes be unreliable in multi-camera reidentification systems due to variations in lighting, pose, occlusions, and camera viewpoints that cause significant changes in a person's appearance. These factors can lead to discrepancies in the embeddings, resulting in decreased accuracy in matching and tracking individuals across cameras.

### BRIEF DESCRIPTION OF THE DRAWINGS

FIG. 1 illustrates a system architecture for performing person searching and tracking (PST), according to one embodiment.

FIG. 2 illustrates a data flow for performing PST, according to at least one embodiment;

FIG. 3 illustrates a method for utilizing appearance and attribute features to identify persons within images, in accordance with one embodiment.

FIG. 4 illustrates a method 400 for training one or more artificial intelligence (AI) models, in accordance with one embodiment.

FIG. 5A illustrates inference and/or training logic, according to at least one embodiment of the present disclosure;

FIG. 5B illustrates inference and/or training logic, according to at least one embodiment;

FIG. 6 illustrates training and deployment of a neural network, according to at least one embodiment;

FIG. 7 is an example data flow diagram for an advanced computing pipeline, according to at least one embodiment;

FIG. 8 is a system diagram for an example system for training, adapting, instantiating and deploying machine learning models in an advanced computing pipeline, according to at least one embodiment.

FIG. 9 illustrates a computer system, according to at least one embodiment.

FIG. 10 illustrates a computer system, according to at least one embodiment.

### DETAILED DESCRIPTION

Multi-camera artificial intelligence (AI) applications, such as Person Search and Tracking (PST), rely on identifying individuals across non-overlapping videos captured by various camera sensors. Traditional person re-identification (ReID) applications use neural networks (“ReID networks”) to capture and analyze the appearance features of individuals to match them across different camera views. This process typically involves extracting embeddings that encapsulate a person's identity and using learning techniques that ensure embeddings of the same individual are grouped closely together, while those of different individuals are positioned further apart. However, these conventional ReID networks overlook valuable fine-grained attribute information, such as age, gender, and clothing, which are essential for improving the accuracy of these downstream applications. In general, pedestrian attribute recognition (PAR) applications use neural networks (“PAR networks”) to detect and recognize this type of attribute information. However, generally, ReID networks and PAR networks have differing purposes and methodologies: ReID networks often use learning architectures and loss functions like triplet loss or contrastive loss to distinguish between identities, while PAR networks focus on learning discriminative features for specific attributes.

Aspects and embodiments of the present disclosure provide an ReID with PAR (ReID+PAR) application (also referred to herein as “the application”) that integrates attribute-level features along with appearance features into a unified embedding to enhance the accuracy of multi-camera AI applications, such as PST. The application may include multiple neural networks (also referred to herein as networks or models) that are each trained to perform different tasks.

A first network may generate attribute-level features (also referred to as attribute features) based on inputted pseudo-semantic data (also referred to as the semantic backbone) that correspond to input images of persons (subjects). Each data item of these pseudo-semantic data may correspond to appearance features of a corresponding person. The first network may be trained using binary non-entropy (BCE) loss.

Each attribute feature generated by the first network may be represented by a confidence score. An attribute re-weighting module may learn relationships among these attribute features and generate re-weighted attribute features based on the learned relationships.

A second network may be an embedding network that is used to generate embeddings based on the attribute features. In at least one embodiment, the second network receives both the attribute features and the pseudo-semantic data as an input. The pseudo-semantic data may be concatenated to the attribute features. The second network may be trained using triplet loss. The second network may be trained to map embeddings of input images such that same or similar appearance and attribute features are mapped closer together within an embedding vector space and different appearance and attribute features are mapped further apart.

A third network may be used to classify the embeddings which correspond to both appearance and attribute features of the corresponding person. Each unique person within the input images may have a unique class. The third network may be trained using identity loss (ID loss), such as a cross-entropy loss. The third network may be trained to classify embeddings based on proximity within the embedding vector space. The classified embeddings may then be used to confirm identification of persons captured by multi-camera applications.

Accordingly, aspects of the present disclosure generate and use reliable embeddings that account for variations in lighting, pose, occlusions, and camera viewpoints that may cause changes in a person's appearance. As a result, accuracy in matching and tracking individuals across cameras is significantly improved.

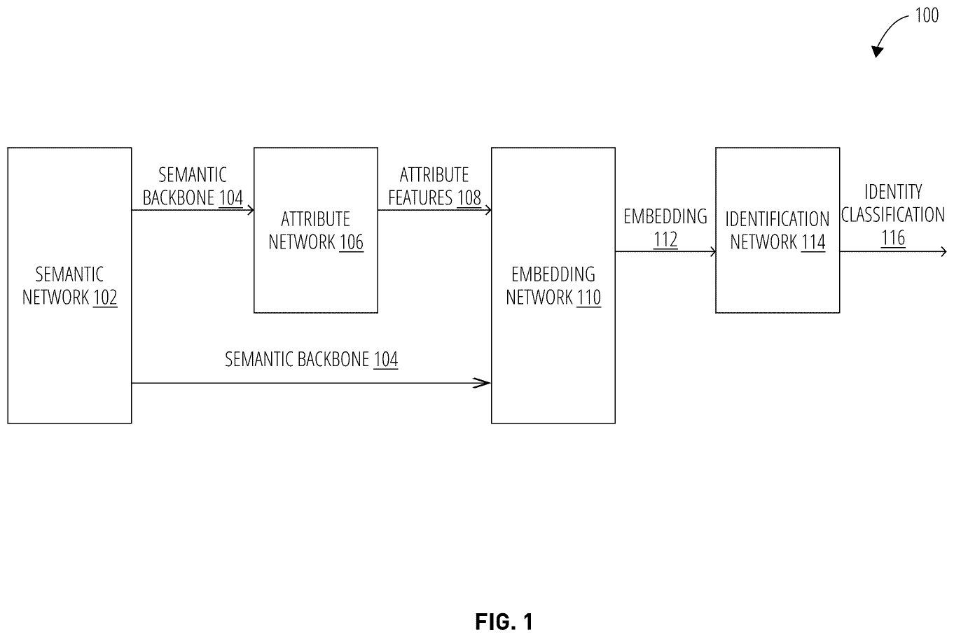

FIG. 1 illustrates a system architecture 100 for performing person searching and tracking (PST), according to one embodiment. The system architecture 100 may include multiple networks, such as a semantic network 102, an attribute network 106, an embedding network 110, and an identification network 114. In embodiments of the present disclosure, these networks are not confined to any specific architecture but encompass any design suitable for effective training and inference in PST applications. For example, convolutional neural networks (CNNs) may be utilized due to their proficiency in extracting spatial hierarchies of features from images. Recurrent neural networks (RNNs), including variants such as long short-term memory (LSTM) networks or gated recurrent units (GRUs), may also be used in some embodiments. Additionally, transformer-based architectures, such as vision transformers (ViTs) may be utilized. Hybrid models that combine different architectural elements are also within the scope of the present disclosure, such as networks that integrate architectural structures of one or more of CNNs with RNNs or transformers. For instance, a CNN-LSTM network may first extract spatial features using CNN layers and then capture temporal dynamics with LSTM layers. The choice of network architecture may be adapted based on the specific requirements of the PST application, such as the need for real-time processing, desired accuracy levels, or computational resource constraints. This flexibility ensures that the system can be optimized for various operational contexts while maintaining robust person searching and tracking capabilities.

The semantic network 102 may be pre-trained using a self-supervised learning technique called self-organizing lifelong intelligent decentralized evolving robust (SOLIDER). This method leverages prior knowledge of image crops of people to generate semantic data, which can be in the form of pseudo-semantic labels, enabling the network to learn semantic features of person objects in an image. These pseudo-semantic labels may also be referred to as semantic backbones 104. Each semantic backbone 104 may represent appearance features corresponding to a person within their respective images. A semantic backbone 104 may be an embedding. Each semantic backbone 104 may capture information of the corresponding image such as patterns, textures, colors, and shapes that uniquely represent the content of the image, particularly the distinguishing attributes of a person depicted therein. SOLIDER helps align similar semantic features of different objects in a vector space, resulting in better clustering of features, such as upper body characteristics, compared to other techniques like distillation with no labels (DINO). By using SOLIDER, the learning of semantic information may be by generating pseudo-semantic labels from unlabeled images, aligning these semantic features in a vector space. This approach can allow for more robust learning of semantic attributes without relying on labeled datasets. The semantic network 102 may be trained using a dataset comprising image crops of people. The architecture of the semantic network 102 may be a shifted window (SWIN) architecture that uses shifted windows to compute representations, enabling the learning of both local and global features of an image crop.

The semantic backbone 104 outputted by the semantic network 102 may be used by the attribute network 106 (also referred to as an attribute recognition network) to generate attribute features 108 (also referred to as attribute-level features). These attribute features 108 may be used for inference. The attribute network 106 may include linear layers. In some embodiments, the attribute network 106 is configured to recognize and extract specific attributes of a person from the semantic backbone 104. These attribute features 108 can correspond to various intrinsic and extrinsic attributes of the person, enabling detailed characterization and identification within person searching and tracking systems. In some embodiments the attribute features 108 can include at least one intrinsic attribute of the person within the image and one extrinsic attribute (e.g., clothing article worn by the person, or an object attached or carried by the person) of the person within the image. For example, these attribute features can correspond to a group of attribute features including, but not limited to, age, gender, bottom clothing item (e.g., pants or dress) type, size, or color, top clothing item (e.g., shirt or dress) type, size, or color, body shape, hair color, facial hair, shirt color, pants color, mask, glasses, hat, or the like. An example of possible attribute features and their corresponding labels is shown below in Table 1:

TABLE 1

| Attribute | Labels |
|---|---|
| Age | Adult, Old, Young |
| Sex | Female, Male |
| Bottom | Capri, Knee, Long, Short |
| Length | |
| Bottom | Capri, Dress, Jeans, Leggings, Skirt, Pants, Shorts |
| Type | |
| Bottom | Beige, Black Blue, Brown, Camouflage, Green, Grey, Orange, Pink, Purple, |
| Color | Red, White, Yellow |
| Top Outer | Long, Short, Medium, None |
| Length | |
| Top Outer | Camisole, Coat, Crop Top, Dress, Hoodie, Jacket, Robe, Skirt, Suit, Sweater, |
| Type | Vest, None |
| Top Inner | Long, Short, Medium |
| Length | |
| Top Inner | Camisole, Crop Top, Hoodie, Shirt, Sweater, T-shirt |
| Type | |
| Top Inner | Beige, Black Blue, Brown, Camouflage, Green, Grey, Orange, Pink, Purple, |
| Color | Red, White, Yellow |
| Shoe | Boots, Dress Shoes, Flats, Flip-flops, High Heels, Loafers, Sandals, Sneakers |
| Type | |
| Shoe | Beige, Black Blue, Brown, Camouflage, Green, Grey, Orange, Pink, Purple, |
| Color | Red, White, Yellow |
| Body | Normal, Thin, Large |
| Shape | |
| Carrying | Backpack, Briefcase, Coat, Fanny Pack, Handbag, Jacket, Luggage Case, |
| Accessory | Mobile, Plastic Bag, Carrying Scarf, Shopping Bag, Shoulder Bag, Suitcase, |
| | Umbrella, Gloves |
| Hair Style | Bald, Long, Short |
| Hat | Yes, No |
| Mask | Yes, No |
| Glasses | Yes, No |

The attribute network 106 may be tailored or extended to recognize additional attributes as desired. This flexibility helps ensure that the system architecture 100 can adapt to various operational contexts and requirements, which can enhance its effectiveness in PST applications.

By identifying and/or extracting these appearance attribute features 108 from the semantic backbone 104 via the attribute network 106, the system architecture 100 can provide more accurate person identification. In some embodiments, the semantic backbone 104 and attribute features 108 can be used to generate a pre-embedding. Each processed image may have an associated pre-embedding. Each pre-embedding may be a numerical representation of the corresponding image. In at least one embodiment, pre-embeddings are generated by combining the attribute features 108 and the semantic backbone 104 for each image (e.g., concatenating the attribute features 108 to the semantic backbone 104 for each image, or concatenating the semantic backbone 104 to the attribute features 108). Pre-embeddings may be utilized in one or more subsequent classification networks (such as the identification network 114) to identify persons. These classification networks may receive the pre-embedding as inputs and may be configured to analyze it to determine the identity of the person or to assign the image to a specific category or class of individuals. By comparing the pre-embedding against a database of known or historical embeddings or by utilizing similarity metrics, the classification networks can accurately identify or verify the person's identity. This process can help enable efficient matching and retrieval operations, facilitating applications such as person re-identification, authentication, and surveillance.

The attribute network 106 may be trained using any suitable loss function, such as a binary cross-entropy (BCE) loss function. BCE loss functions can be utilized to optimize the prediction of person attributes. The BCE loss function may be used in training to evaluate the performance of a binary classification network by measuring the difference between the predicted probabilities and the actual binary labels for each attribute. In the context of attribute network 106 (designed to determine probabilities of intrinsic or extrinsic attributes of a person, as seen above in Table 1), each attribute may be treated as an independent binary classification task, and the attribute network 106 may output a probability score between 0 and 1 for each attribute, indicating the likelihood that the attribute is present in the input image. By applying the BCE loss function to each attribute prediction, the attribute network 106 can receive feedback on the accuracy of its predictions relative to the ground truth labels. During training, the attribute network 106 can adjust its weights to minimize the BCE loss, effectively learning to improve its probability estimates for each attribute.

The embedding network 110 may be used to cluster similar pre-embeddings together and push dissimilar pre-embeddings apart. To do so, the embedding network 110 may be trained using a triplet loss function. The training data may include anchor samples (pre-embeddings and/or corresponding images), positive samples (samples similar to the anchor samples), and negative samples (samples dissimilar to the anchor samples). In short, the objective of the triplet loss function is to train the embedding network 110 such that distances within an embedding space between anchor and positive samples are shorter than distances between anchor and negative samples. Once trained, the embedding network 110 outputs embeddings 112. These embeddings 112 may be refined or transformed embeddings that are based on the pre-embeddings constructed using the semantic backbones 104 and attribute features 108. These embeddings 112 may be used for inference. The embedding network 110 may also be trained using any other suitable loss function that clusters similar pre-embeddings together and pushes dissimilar pre-embeddings apart.

The identification network 114 may be used to classify these embeddings 112. In some embodiments, an identification network 114 is configured to receive the embeddings 112 and determine probabilities that these embeddings 112 belong to different classifications. This may be referred to as an identity classification 116. Each classification may correspond to a distinct identity or person. To determine the identity classification 116, the identification network 114 may process these embeddings 112 to output a probability distribution over a set of known classifications (i.e., a set of known identifies), effectively performing multi-class classification to identify the person associated with each embedding. In some embodiments, the identity classification 116 may refer to the probabilities outputted related to this multi-class classification. The identification network 114 may be trained using an identification loss function (ID loss), which may be designed to optimize the ability of the identification network 114 to correctly classify embeddings 112 into their respective identities. The ID loss function can measure the discrepancy between the predicted probability distributions and the true identity labels of the training data. Commonly, an ID loss function can be implemented as a categorical cross-entropy loss, which encourages the identification network 114 to assign higher probabilities to the correct identities while minimizing the probabilities of incorrect ones. By minimizing the ID loss during training, the identification network 114 learns to map embeddings 112 to the correct identities with greater accuracy. This process involves adjusting weights of the identification network 114 to improve its classification performance across the training dataset. The identification network 114 may also be trained using any suitable loss function that allows the identification network 114 to learn to map embeddings 112 to correct identities with greater accuracy.

In some embodiments, two or more of the attribute network 106, the embedding network 110, or the identification network 114 may be jointly trained. During training, multiple forward passes may be performed, where inputs are passed through all the network layers and activation functions of the architecture 100. In at least one embodiment, the semantic network 102 may be pre-trained before some or all of the attribute network 106, embedding network 110, and identification network 114 are trained (or jointly trained). Corresponding to each forward pass, each of these networks 106, 110, 114 may compute its own loss value based on its specific output and task. For example, the attribute network 106 may compute a first loss value based on a first loss function (e.g., BCE loss), the embedding network 110 may compute a second loss value based on a second loss function (e.g., triplet loss), and the identification network 114 may compute a third loss value based on a third loss function (e.g., ID loss). These loss functions may be calculated independently over each forward pass, based on the respective outputs of each network 106, 110, 114 and their individual targets. These individual loss values may be combined into a single combined (total) loss value, as shown in exemplary Equation (1):

$${L}_{iotal} = {λ}_{1} \times ( {L}_{ID} + {L}_{Triplet} ) + {λ}_{2} \times {L}_{BCE} \qquad Equation ( 1 )$$

The overall training process involves combining these individual losses into a single objective, typically through a weighted sum of the loss functions, to reflect the relative importance of each network's contribution to the overall task. λ₁ and λ₂ may each be hyperparameters that control relative importance between the loss values calculated by the loss functions of the different networks 106, 110, 114.

Once the individual losses are calculated, gradients may also be computed independently for each network 106, 110, 114 with respect to its parameters by backpropagating the respective loss through the network. Each network 106, 110, 114 may thus compute the partial derivatives of its loss function with respect to its own parameters. After computing these individual gradients, these independent gradients may be combined into a combined (total) gradient, often by summing the gradients or using weighted contributions corresponding to the loss weighting. According to embodiments, these individual gradients may be combined into the combined gradient as shown below in exemplary Equation (2), where θ represents parameters and ∂/∂θ represents a gradient (e.g., partial differential) of a parameter:

$$\frac{\partial {L}_{total}}{\partial θ} = {λ}_{1} \times ( \frac{\partial {L}_{ID}}{\partial θ} + \frac{\partial {L}_{Triplet}}{\partial θ} ) + {λ}_{2} \times \frac{\partial {L}_{BCE}}{\partial θ} \qquad Equation ( 2 )$$

This combined gradient is then used to update all the parameters of the networks in a single optimization step, typically through an algorithm like stochastic gradient descent (SGD) or the like. Jointly training multiple networks in this way can allow for concurrent optimization of distinct tasks while helping ensure that the parameters the updated networks (e.g., two or more of the attribute network 106, embedding network 110, or identification network 114) are updated in a coordinated manner. In embodiments where each of the attribute network 106, embedding network 110, and identification network 114, are jointly trained, updating the parameters (e.g., weights) of each of these networks based on the combined loss gradient allows the architecture 100 to optimize all three losses concurrently, learning a compact and discriminative embedding space that is effective for both reidentification (ReID) and person attribute recognition (PAR) tasks while also increasing prediction accuracy of the attributes of the input image. In some embodiments, without the total loss or total gradient, the application 100 would only optimize each loss in isolation, which might lead to imbalance and/or underfitting during the learning process. According to embodiments, the parameters may be updated according to an update rule, such as is shown in exemplary Equation (3), where η is the learning rate:

$$θ = θ - η \times \frac{\partial {L}_{total}}{\partial θ} \qquad Equation ( 3 )$$

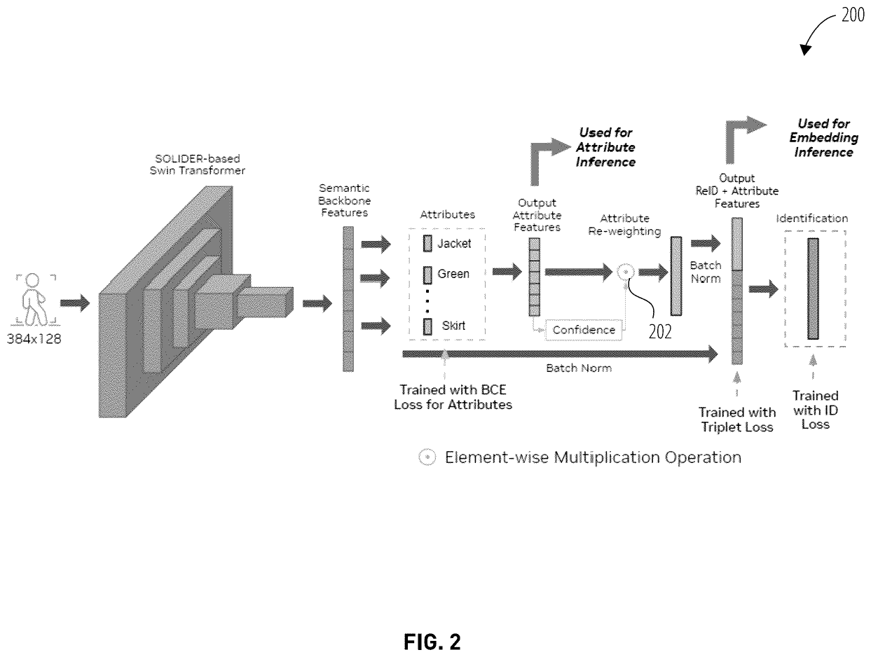

FIG. 2 illustrates a data flow for performing PST, according to one embodiment. The data flow may include attribute re-weighting operation(s) 202 that allow attribute features 108 to be re-weighted based on recognized patterns within historical attribute features 108. For example, if the historical attribute features 108 indicate that men are significantly less likely to wear skirts than women, then the attribute re-weighting operation(s) 202 may cause a confidence score (or likelihood) associated with a person wearing a skirt to be lowered if a confidence score associated with a person being a male is significantly high (e.g., greater than a confidence score associated with a person being a female). In other words, the attribute re-weighting operation(s) 202 may capture learned relationships between attribute features 108 and re-weight probabilities (i.e., confidence scores) of each attribute feature 108 accordingly.

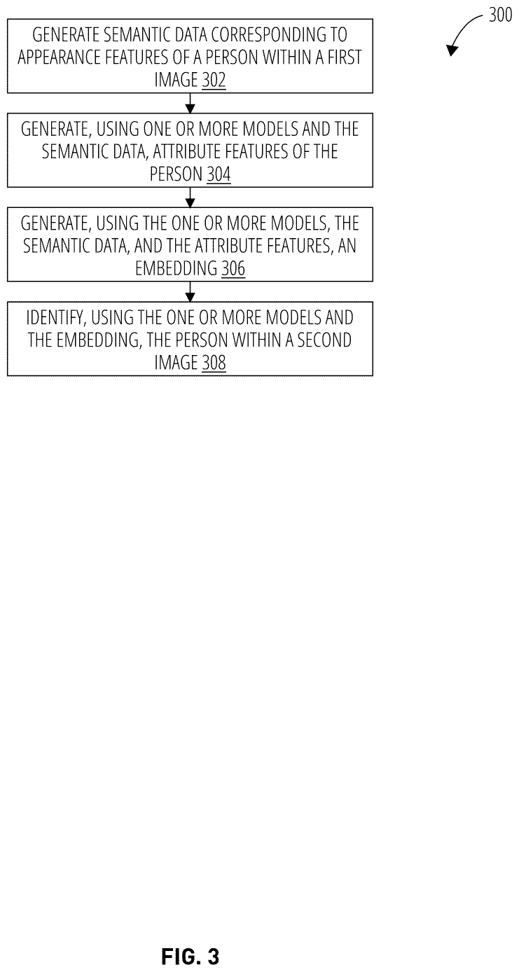

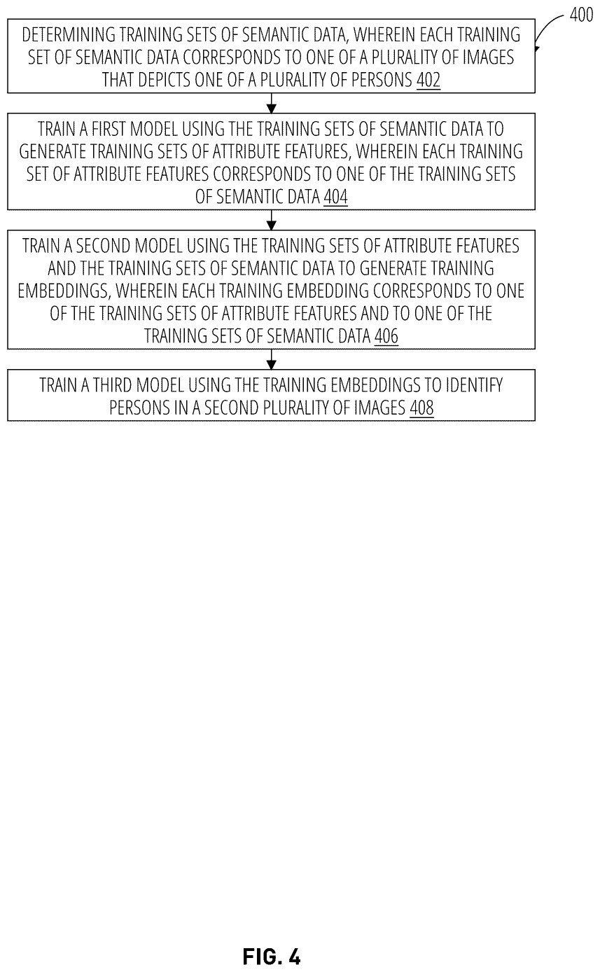

FIG. 3 is a flow diagram of an example method 300 for utilizing appearance and attribute features to identify persons within images, according to one embodiment. FIG. 4 is a flow diagram of an example method 400 for training one or more AI models to identify persons based on appearance and attributes features within images.

Methods 300, 400 can be performed using one or more processing units (e.g., CPUs, GPUs, accelerators, physics processing units (PPUs), data processing units (DPUs), etc.), which may include (or communicate with) one or more memory devices. In at least one embodiment, any of methods 300, 400 can be performed using a processing device or processing devices. In at least one embodiment, methods 300, 400 can be performed using processing units of as described herein. In at least one embodiment, methods 300, 400 can be performed by application 100 of FIG. 1. In at least one embodiment, processing units performing any of methods 300, 400 can be executing instructions stored on a non-transient computer readable storage media. In at least one embodiment, any of methods 300, 400 can be performed using multiple processing threads (e.g., CPU threads and/or GPU threads), individual threads executing one or more individual functions, routines, subroutines, or operations of the method. In at least one embodiment, processing threads implementing any of methods 300, 400 can be synchronized (e.g., using semaphores, critical sections, and/or other thread synchronization mechanisms). Alternatively, processing threads implementing any of methods 300, 400 can be executed asynchronously with respect to each other. Various operations of methods 300, 400 can be performed in a different order compared with the order shown in FIG. 3. Some operations of methods 300, 400 can be performed concurrently with other operations. In at least one embodiment, one or more operations shown in FIG. 3 or FIG. 4 may not always be performed.

FIG. 3 is a flow diagram of an example method 300 for utilizing appearance and attribute features to identify persons within images, according to one embodiment.

At block 302, processing units executing the method 300 can generate or otherwise obtain semantic data corresponding to appearance features of a person within a first image. This semantic data may be the semantic backbone 104 as described herein. A pre-trained network may generate the semantic data using the first image. This pre-trained network may be a semantic controllable self-supervised learning framework (SOLIDER).

At block 304, processing units executing method 300 can generate, using one or more networks and the semantic data, attribute features of the person. These attribute features may be the attribute features 108, as described herein. In at least one embodiment, a first network (e.g., the attribute network 106) is trained to generate these attribute features using a first loss function, which may be a BCE loss function or another suitable loss function. During training, the first network may be trained to generate training attribute features from training semantic data (semantic backbones 104 generated during training) associated with a second person in an initial image.

At block 306, processing units executing method 300 can generate, using the one or more networks, the semantic data, and the attribute features, an embedding. This embedding may be the embedding 112, as described herein. In at least one embodiment, a second network (e.g., the embedding network 110) is trained to generate these embeddings using a second loss function, which may be a triplet loss function. The first and second loss functions may be different. During training, the second network may be trained to generate a training embedding using the training semantic data and the training attribute features. This training embedding may correspond to the second person and the initial image. Embeddings or training embeddings generated by the second network may be based on weights derived from relationships between the attribute features and the appearance features.

At block 308, processing units executing method 300 can identify, using the one or more networks and the embedding, the person within a second image. In at least one embodiment, a third network (e.g., identification network 14) may be trained to identify persons within images. During training, the third network may be trained to identify the second person within a subsequent image using the training embedding and a third loss function, such as an ID loss function. The third loss function may be different from one or more of the first and second loss functions.

FIG. 4 is a flow diagram of an example method 400 for training one or more AI models to identify persons based on appearance and attributes features within images.

At block 402, processing units executing method 400 can determine training sets of semantic data. In some embodiments, each training set of semantic data corresponds to one of a plurality of images that depicts one of a plurality of persons.

At block 404, processing units executing method 400 can train a first network (first AI model) using the training sets of semantic data to generate training sets of attribute features. In some embodiments, each training set of attribute features corresponds to one of the training sets of semantic data.

At block 406, processing units executing method 400 can train a second network (second AI model) using the training sets of attribute features and the training sets of semantic data to generate training embeddings. In some embodiments, each training embedding corresponds to one of the training sets of attribute features and to one of the training sets of semantic data.

At block 408, processing units executing method 400 can train a third network (third AI model) using the training embeddings to identify persons in a second plurality of images. In some embodiments, parameters of the second and third AI models may be jointly updated based on a combined loss gradient algorithm that combines a first loss gradient corresponding to the second network and a second loss gradient corresponding to the third network.

### Inference and Training Logic

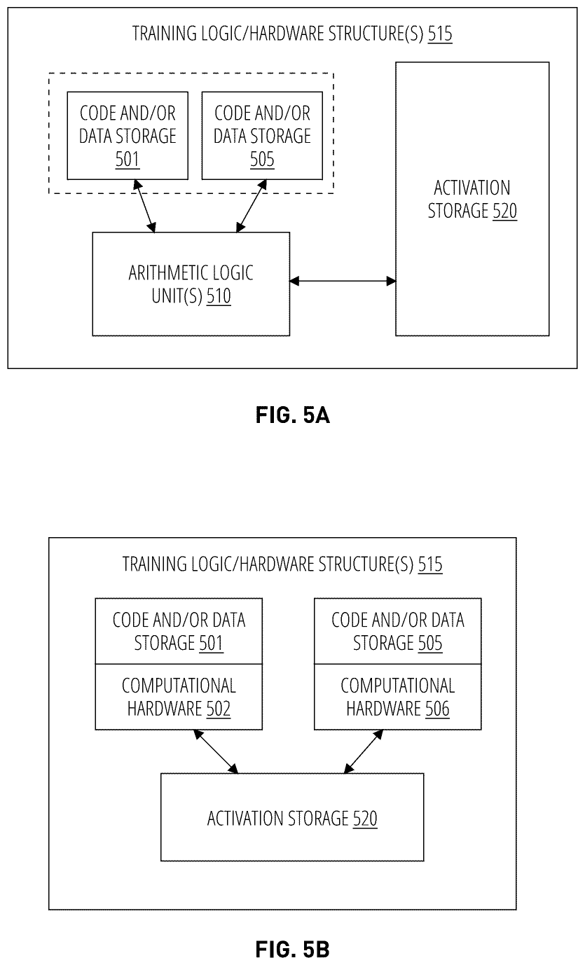

FIG. 5A illustrates inference and/or training logic 515 used to perform inferencing and/or training operations associated with one or more embodiments.

In at least one embodiment, inference and/or training logic 515 may include, without limitation, code and/or data storage 501 to store forward and/or output weight and/or input/output data, and/or other parameters to configure neurons or layers of a neural network trained and/or used for inferencing in aspects of one or more embodiments. In at least one embodiment, training logic 515 may include (or be coupled to code and/or data storage 501 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 501 may be included with other on-chip or off-chip data storage, including a processor's L1, L2, or L3 cache or system memory.

In at least one embodiment, any portion of code and/or data storage 501 may be internal or external to one or more processors or other hardware logic devices or circuits. In at least one embodiment, code and/or data storage 501 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 501 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a code and/or data storage 505 to store backward and/or output weight and/or input/output data corresponding to neurons or layers of a neural network trained and/or used for inferencing in aspects of one or more embodiments. In at least one embodiment, code and/or data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 515 may include (or be coupled to code and/or data storage 505 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 505 may be included with other on-chip or off-chip data storage, including a processor's L1, L2, or L3 cache or system memory. In at least one embodiment, any portion of code and/or data storage 505 may be internal or external to one or more processors or other hardware logic devices or circuits. In at least one embodiment, code and/or data storage 505 may be cache memory, DRAM, SRAM, non-volatile memory (e.g., flash memory), or other storage. In at least one embodiment, a choice of whether code and/or data storage 505 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or code and/or data storage 501 and code and/or data storage 505 may be separate storage structures. In at least one embodiment, code and/or data storage 501 and code and/or data storage 505 may be a combined storage structure. In at least one embodiment, code and/or data storage 501 and code and/or data storage 505 may be partially combined and partially separate. In at least one embodiment, any portion of code and/or data storage 501 and code and/or data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 520 that are functions of input/output and/or weight parameter data stored in code and/or data storage 501 and/or code and/or data storage 505. In at least one embodiment, activations stored in activation storage 520 are generated according to linear algebraic and/or matrix-based mathematics performed by ALU(s) 510 in response to performing instructions or other code, wherein weight values stored in code and/or data storage 505 and/or code and/or data storage 501 are used as operands along with other values, such as bias values, gradient information, momentum values, or other parameters or hyperparameters, any or all of which may be stored in code and/or data storage 505 or code and/or code and/or data storage 501 or another storage on or off-chip.

In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALU(s) 510 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 501, code and/or data storage 505, and activation storage 520 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., flash memory), or other storage. In at least one embodiment, activation storage 520 may be completely or partially within or external to one or more processors or other logical circuits. In at least one embodiment, a choice of whether activation storage 520 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 illustrated in FIG. 5A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, code and/or data storage 501 and code and/or data storage 505, which may be used to store code (e.g., graph code), weight values and/or other information, including bias values, gradient information, momentum values, and/or other parameter or hyperparameter information. In at least one embodiment illustrated in FIG. 5B, each of code and/or data storage 501 and code and/or data storage 505 is associated with a dedicated computational resource, such as computational hardware 502 and computational hardware 506, respectively. In at least one embodiment, each of computational hardware 502 and computational hardware 506 comprises one or more ALUs that perform mathematical functions, such as linear algebraic functions, only on information stored in code and/or data storage 501 and code and/or data storage 505, respectively, the result of which is stored in activation storage 520.

In at least one embodiment, each of code and/or data storage 501 and 505 and corresponding computational hardware 502 and 506, respectively, correspond to different layers of a neural network, such that resulting activation from one storage/computational pair 501/502 of code and/or data storage 501 and computational hardware 502 is provided as an input to a next storage/computational pair 505/506 of code and/or data storage 505 and computational hardware 506, in order to mirror a conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage/computation pairs 501/502 and 505/506 may be included in inference and/or training logic 515.

### Neural Network Training and Deployment

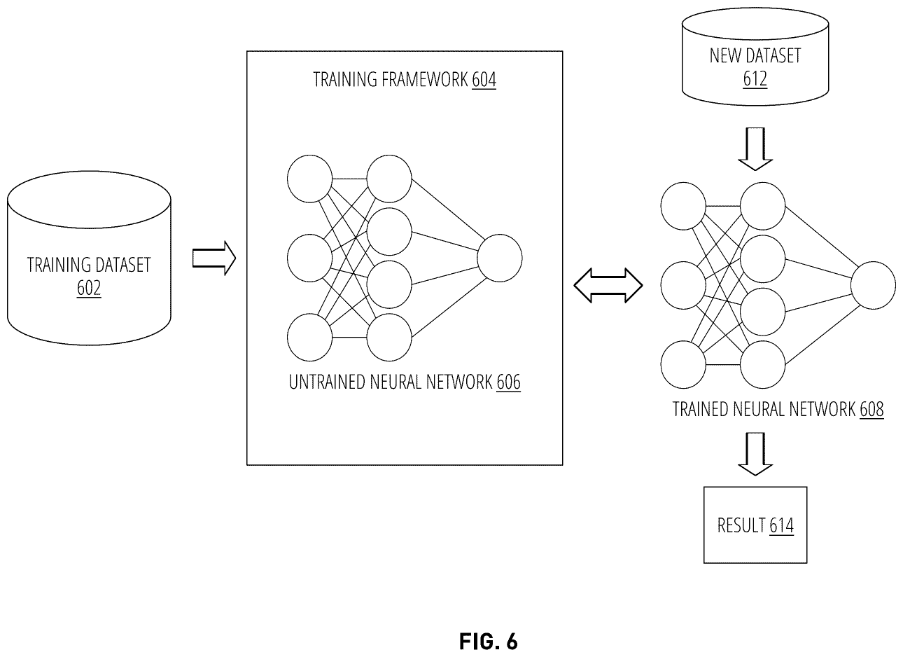

FIG. 6 illustrates training and deployment of a deep neural network, according to at least one embodiment. In at least one embodiment, untrained neural network 606 is trained using a training dataset 602. In at least one embodiment, training framework 604 is a PyTorch framework, whereas in other embodiments, training framework 604 is a TensorFlow, Boost, Caffe, Microsoft Cognitive Toolkit/CNTK, MXNet, Chainer, Keras, Deeplearning4j, or other training framework. In at least one embodiment, training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having a known output and an output of neural network 606 is manually graded. In at least one embodiment, untrained neural network 606 is trained in a supervised manner and processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on input data such as a new dataset 612. In at least one embodiment, training framework 604 trains untrained neural network 606 repeatedly while adjusting weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map in trained neural network 608 capable of performing operations useful in reducing dimensionality of new dataset 612. In at least one embodiment, unsupervised training can also be used to perform anomaly detection, which allows identification of data points in new dataset 612 that deviate from normal patterns of new dataset 612.

In at least one embodiment, semi-supervised learning may be used, which is a technique in which training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new dataset 612 without forgetting knowledge instilled within trained neural network 608 during initial training.

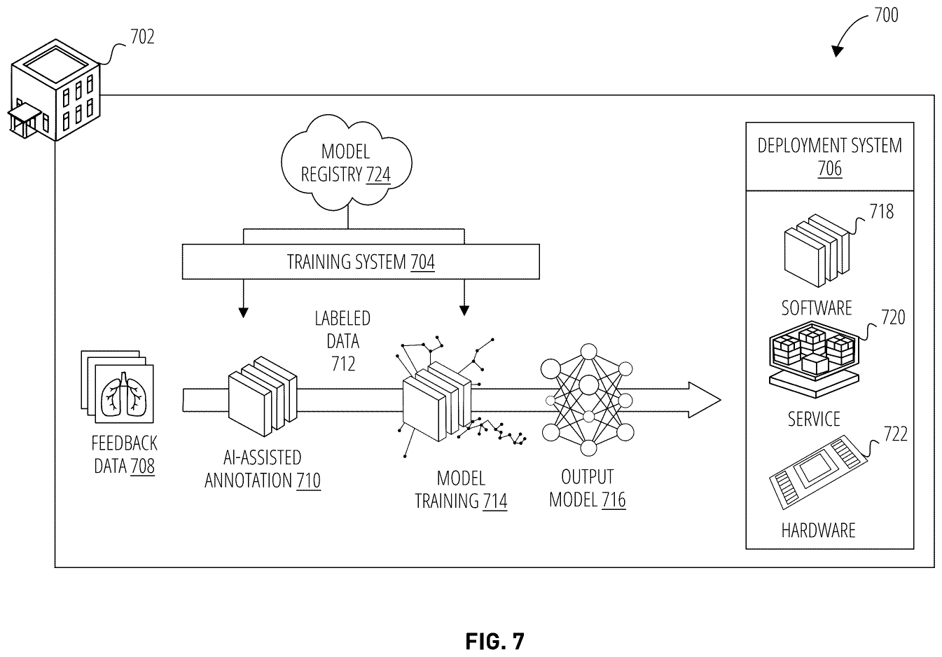

With reference to FIG. 7, FIG. 7 is an example data flow diagram for a process 700 of generating and deploying a processing and inferencing pipeline, according to at least one embodiment. In at least one embodiment, process 700 may be deployed to perform game name recognition analysis and inferencing on user feedback data at one or more facilities 702, such as a data center.

In at least one embodiment, process 700 may be executed within a training system 704 and/or a deployment system 706. In at least one embodiment, training system 704 may be used to perform training, deployment, and embodiment of machine learning models (e.g., neural networks, object detection algorithms, computer vision algorithms, etc.) for use in deployment system 706. In at least one embodiment, deployment system 706 may be configured to offload processing and compute resources among a distributed computing environment to reduce infrastructure requirements at facility 702. In at least one embodiment, deployment system 706 may provide a streamlined platform for selecting, customizing, and implementing virtual instruments for use with computing devices at facility 702. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 706 during execution of applications.

In at least one embodiment, some applications used in advanced processing and inferencing pipelines may use machine learning models or other AI to perform one or more processing steps. In at least one embodiment, machine learning models may be trained at facility 702 using feedback data 708 (such as imaging data) stored at facility 702 or feedback data 708 from another facility or facilities, or a combination thereof. In at least one embodiment, training system 704 may be used to provide applications, services, and/or other resources for generating working, deployable machine learning models for deployment system 706.

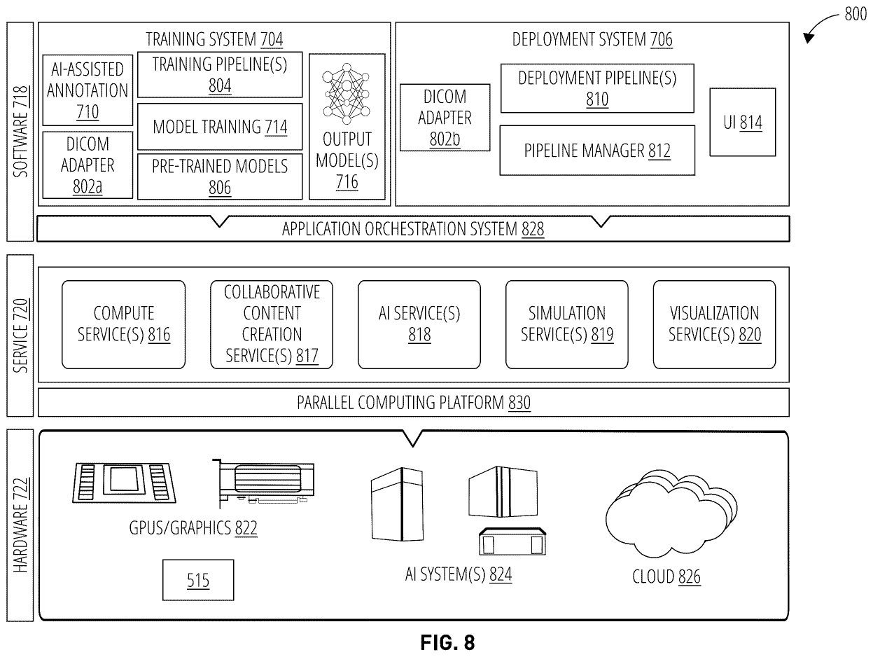

In at least one embodiment, a model registry 724 may be backed by object storage that may support versioning and object metadata. In at least one embodiment, object storage may be accessible through, for example, a cloud storage (e.g., a cloud 826 of FIG. 8) compatible application programming interface (API) from within a cloud platform. In at least one embodiment, machine learning models within model registry 724 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 804 (FIG. 8) may include a scenario where facility 702 is training their own machine learning model or has an existing machine learning model that needs to be optimized or updated. In at least one embodiment, feedback data 708 may be received from various channels, such as forums, web forms, or the like. In at least one embodiment, once feedback data 708 is received, AI-assisted annotation 710 may be used to aid in generating annotations corresponding to feedback data 708 to be used as ground truth data for a machine learning model. In at least one embodiment, AI-assisted annotation 710 may include one or more machine learning models (e.g., convolutional neural networks (CNNs)) that may be trained to generate annotations corresponding to certain types of feedback data 708 (e.g., from certain devices) and/or certain types of anomalies in feedback data 708. In at least one embodiment, AI-assisted annotations 710 may then be used directly, or may be adjusted or fine-tuned using an annotation tool, to generate ground truth data. In at least one embodiment, in some examples, labeled data 712 may be used as ground truth data for training a machine learning model. In at least one embodiment, AI-assisted annotations 710, labeled data 712, or a combination thereof may be used as ground truth data for training a machine learning model, e.g., via model training 714 in FIG. 7 and/or FIG. 8. In at least one embodiment, a trained machine learning model may be referred to as an output model 716, and may be used by deployment system 706, as described herein.

In at least one embodiment, training pipeline(s) 804 (FIG. 8) may include a scenario where facility 702 needs a machine learning model for use in performing one or more processing tasks for one or more applications in deployment system 706, but facility 702 may not currently have such a machine learning model (or may not have a model that is optimized, efficient, or effective for such purposes). In at least one embodiment, an existing machine learning model may be selected from model registry 724. In at least one embodiment, model registry 724 may include machine learning models trained to perform a variety of different inference tasks on imaging data. In at least one embodiment, machine learning models in model registry 724 may have been trained on imaging data from different facilities than facility 702 (e.g., facilities that are remotely located). In at least one embodiment, machine learning models may have been trained on imaging data from one location, two locations, or any number of locations. In at least one embodiment, when being trained on imaging data, which may be a form of feedback data 708, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 724. In at least one embodiment, a machine learning model may then be retrained, or updated, at any number of other facilities, and a retrained or updated model may be made available in model registry 724. In at least one embodiment, a machine learning model may then be selected from model registry 724—and referred to as output model(s) 716—and may be used in deployment system 706 to perform one or more processing tasks for one or more applications of a deployment system.

In at least one embodiment, training pipeline(s) 804 (FIG. 8) may be used in a scenario that includes facility 702 requiring a machine learning model for use in performing one or more processing tasks for one or more applications in deployment system 706, but facility 702 may not currently have such a machine learning model (or may not have a model that is optimized, efficient, or effective for such purposes). In at least one embodiment, a machine learning model selected from model registry 724 might not be fine-tuned or optimized for feedback data 708 generated at facility 702 because of differences in populations, genetic variations, robustness of training data used to train a machine learning model, diversity in anomalies of training data, and/or other issues with training data. In at least one embodiment, AI-assisted annotation 710 may be used to aid in generating annotations corresponding to feedback data 708 to be used as ground truth data for retraining or updating a machine learning model. In at least one embodiment, labeled data 712 may be used as ground truth data for training a machine learning model. In at least one embodiment, retraining or updating a machine learning model may be referred to as model training 714. In at least one embodiment, model training 714 may include data—e.g., AI-assisted annotations 710, labeled data 712, or a combination thereof—that may be used as ground truth data for retraining or updating a machine learning model.

In at least one embodiment, deployment system 706 may include software 718, service 720, hardware 722, and/or other components, features, and functionality. In at least one embodiment, deployment system 706 may include a software “stack,” such that software 718 may be built on top of service 720 and may use service 720 to perform some or all of processing tasks, and service 720 and software 718 may be built on top of hardware 722 and use hardware 722 to execute processing, storage, and/or other compute tasks of deployment system 706.

In at least one embodiment, software 718 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 708 (or other data types, such as those described herein). In at least one embodiment, an advanced processing and inferencing pipeline may be defined based on selections of different containers that are desired or required for processing feedback data 708, in addition to containers that receive and configure imaging data for use by each container and/or for use by facility 702 after processing through a pipeline (e.g., to convert outputs back to a usable data type for storage and display at facility 702). In at least one embodiment, a combination of containers within software 718 (e.g., that make up a pipeline) may be referred to as a virtual instrument (as described in more detail herein), and a virtual instrument may leverage service 720 and hardware 722 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 716 of training system 704.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 724 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 720 as a system (e.g., system 800 of FIG. 8). In at least one embodiment, once validated by system 800 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 800 of FIG. 8). In at least one embodiment, completed and validated applications or containers may be stored in a container registry and associated machine learning models may be stored in model registry 724. In at least one embodiment, a requesting entity that provides an inference or image processing request may browse a container registry and/or model registry 724 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 706 (e.g., a cloud) to perform processing of a data processing pipeline. In at least one embodiment, processing by deployment system 706 may include referencing selected elements (e.g., applications, containers, models, etc.) from a container registry and/or model registry 724. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 720 may be leveraged. In at least one embodiment, service 720 may include compute services, collaborative content creation services, simulation services, artificial intelligence (AI) services, visualization services, and/or other service types. In at least one embodiment, service 720 may provide functionality that is common to one or more applications in software 718, so functionality may be abstracted to a service that may be called upon or leveraged by applications. In at least one embodiment, functionality provided by service 720 may run dynamically and more efficiently, while also scaling well by allowing applications to process data in parallel, e.g., using a parallel computing platform 830 (FIG. 8). In at least one embodiment, rather than each application that shares a same functionality offered by a service 720 being required to have a respective instance of service 720, service 720 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 720 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 718 implementing advanced processing and inferencing pipeline may be streamlined because each application may call upon the same inference service to perform one or more inferencing tasks.

In at least one embodiment, hardware 722 may include GPUs, CPUs, data processing units (DPUs), an AI/deep learning system (e.g., an AI supercomputer, such as NVIDIA's DGX™ supercomputer system), a cloud platform, or a combination thereof. In at least one embodiment, different types of hardware 722 may be used to provide efficient, purpose-built support for software 718 and service 720 in deployment system 706. In at least one embodiment, use of GPU processing may be implemented for processing locally (e.g., at facility 702), within an AI/deep learning system, in a cloud system, and/or in other processing components of deployment system 706 to improve efficiency, accuracy, and efficacy of game name recognition.

In at least one embodiment, software 718 and/or service 720 may be optimized for GPU processing with respect to deep learning, machine learning, and/or high-performance computing, simulation, and visual computing, as non-limiting examples. In at least one embodiment, at least some of the computing environment of deployment system 706 and/or training system 704 may be executed in a datacenter or one or more supercomputers or high performance computing systems, with GPU-optimized software (e.g., hardware and software combination of NVIDIA's DGX™ system). In at least one embodiment, hardware 722 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 8 is a system diagram for an example system 800 for generating and deploying a deployment pipeline, according to at least one embodiment. In at least one embodiment, system 800 may be used to implement process 700 of FIG. 7 and/or other processes including advanced processing and inferencing pipelines. In at least one embodiment, system 800 may include training system 704 and deployment system 706. In at least one embodiment, training system 704 and deployment system 706 may be implemented using software 718, services 720, and/or hardware 722, as described herein.

In at least one embodiment, system 800 (e.g., training system 704 and/or deployment system 706) may implemented in a cloud computing environment (e.g., using cloud 826). In at least one embodiment, system 800 may be implemented locally with respect to a facility, or as a combination of both cloud and local computing resources. In at least one embodiment, access to APIs in cloud 826 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 800, may be restricted to a set of public internet service providers (ISPs) that have been vetted or authorized for interaction.

In at least one embodiment, various components of system 800 may communicate between and among one another using any of a variety of different network types, including but not limited to local area networks (LANs) and/or wide area networks (WANs) via wired and/or wireless communication protocols. In at least one embodiment, communication between facilities and components of system 800 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 704 may execute training pipelines 804, similar to those described herein with respect to FIG. 7. In at least one embodiment, where one or more machine learning models are to be used in deployment pipeline(s) 810 by deployment system 706, training pipeline(s) 804 may be used to train or retrain one or more (e.g., pre-trained) models, and/or implement one or more of pre-trained models 806 (e.g., without a need for retraining or updating). In at least one embodiment, as a result of training pipeline(s) 804, output model(s) 716 may be generated. In at least one embodiment, training pipeline(s) 804 may include any number of processing steps, AI-assisted annotation 710, labeling or annotating of feedback data 708 to generate labeled data 712, model selection from a model registry, model training 714, training, retraining, or updating models, and/or other processing steps. In at least one embodiment, DICOM adapter 802a can be used to access DICOM data. In at least one embodiment, for different machine learning models used by deployment system 706, different training pipeline(s) 804 may be used. In at least one embodiment, training pipeline(s) 804, similar to a first example described with respect to FIG. 7, may be used for a first machine learning model, training pipeline(s) 804, similar to a second example described with respect to FIG. 7, may be used for a second machine learning model, and training pipeline(s) 804, similar to a third example described with respect to FIG. 7, may be used for a third machine learning model. In at least one embodiment, any combination of tasks within training system 704 may be used depending on what is required for each respective machine learning model. In at least one embodiment, one or more of machine learning models may already be trained and ready for deployment so machine learning models may not undergo any processing by training system 704 and may be implemented by deployment system 706.

In at least one embodiment, output model(s) 716 and/or pre-trained models 806 may include any types of machine learning models depending on embodiment. In at least one embodiment, and without limitation, machine learning models used by system 800 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 804 may include AI-assisted annotation. In at least one embodiment, labeled data 712 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 708 (or other data type used by machine learning models), there may be corresponding ground truth data generated by training system 704. In at least one embodiment, AI-assisted annotation may be performed as part of deployment pipeline(s) 810; either in addition to, or in lieu of, AI-assisted annotation included in training pipeline(s) 804. In at least one embodiment, system 800 may include a multi-layer platform that may include a software layer (e.g., software 718) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 702. In at least one embodiment, applications may then call or execute one or more services 720 for performing compute, AI, or visualization tasks associated with respective applications, and software 718 and/or services 720 may leverage hardware 722 to perform processing tasks in an effective and efficient manner.

In at least one embodiment, deployment system 706 may execute deployment pipelines 810. In at least one embodiment, deployment pipeline(s) 810 may include any number of applications that may be sequentially, non-sequentially, or otherwise applied to feedback data (and/or other data types), including AI-assisted annotation, as described above. In at least one embodiment, as described herein, a deployment pipeline(s) 810 for an individual device may be referred to as a virtual instrument for a device. In at least one embodiment, for a single device, there may be more than one deployment pipeline(s) 810 depending on information desired from data generated by a device.

In at least one embodiment, applications available for deployment pipeline(s) 810 may include any application that may be used for performing processing tasks on feedback data or other data from devices. In at least one embodiment, because various applications may share common image operations, in some embodiments, a data augmentation library (e.g., as one of services 720) may be used to accelerate these operations. In at least one embodiment, to avoid bottlenecks of conventional processing approaches that rely on CPU processing, parallel computing platform 830 may be used for GPU acceleration of these processing tasks.

In at least one embodiment, deployment system 706 may include a user interface (UI) 814 (e.g., a graphical user interface, a web interface, etc.) that may be used to select applications for inclusion in deployment pipeline(s) 810, arrange applications, modify or change applications or parameters or constructs thereof, use and interact with deployment pipeline(s) 810 during set-up and/or deployment, and/or to otherwise interact with deployment system 706. In at least one embodiment, although not illustrated with respect to training system 704, UI 814 (or a different user interface) may be used for selecting models for use in deployment system 706, for selecting models for training, or retraining, in training system 704, and/or for otherwise interacting with training system 704.

In at least one embodiment, pipeline manager 812 may be used, in addition to an application orchestration system 828, to manage interaction between applications or containers of deployment pipeline(s) 810 and services 720 and/or hardware 722. In at least one embodiment, pipeline manager 812 may be configured to facilitate interactions from application to application, from application to service 720, and/or from application or service to hardware 722. In at least one embodiment, although illustrated as included in software 718, this is not intended to be limiting, and in some examples pipeline manager 812 may be included in services 720. In at least one embodiment, application orchestration system 828 (e.g., Kubernetes, DOCKER, etc.) may include a container orchestration system that may group applications into containers as logical units for coordination, management, scaling, and deployment. In at least one embodiment, by associating applications from deployment pipeline(s) 810 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 812 and application orchestration system 828. In at least one embodiment, so long as an expected input and/or output of each container or application is known by a system (e.g., based on constructs of applications or containers), application orchestration system 828 and/or pipeline manager 812 may facilitate communication among and between, and sharing of resources among and between, each of the applications or containers. In at least one embodiment, because one or more of applications or containers in deployment pipeline(s) 810 may share the same services and resources, application orchestration system 828 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 828) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 720 leveraged and shared by applications or containers in deployment system 706 may include compute service(s) 816, collaborative content creation service(s) 817, AI service(s) 818, simulation service(s) 819, visualization service(s) 820, and/or other service types. In at least one embodiment, applications may call (e.g., execute) one or more of services 720 to perform processing operations for an application. In at least one embodiment, compute service(s) 816 may be leveraged by applications to perform super-computing or other high-performance computing (HPC) tasks. In at least one embodiment, compute service(s) 816 may be leveraged to perform parallel processing (e.g., using a parallel computing platform 830) for processing data through one or more of applications and/or one or more tasks of a single application, substantially simultaneously. In at least one embodiment, parallel computing platform 830 (e.g., NVIDIA's CUDA®) may enable general purpose computing on GPUs (GPGPU) (e.g., GPUs/graphics 822). In at least one embodiment, a software layer of parallel computing platform 830 may provide access to virtual instruction sets and parallel computational elements of GPUs, for execution of compute kernels. In at least one embodiment, parallel computing platform 830 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 830 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 818 may be leveraged to perform inferencing services for executing machine learning model(s) associated with applications (e.g., tasked with performing one or more processing tasks of an application). In at least one embodiment, AI service(s) 818 may leverage AI system(s) 824 to execute machine learning model(s) (e.g., neural networks, such as CNNs) for segmentation, reconstruction, object detection, feature detection, classification, and/or other inferencing tasks. In at least one embodiment, applications of deployment pipeline(s) 810 may use one or more of output model(s) 716 from training system 704 and/or other models of applications to perform inference on imaging data (e.g., DICOM data, RIS data, CIS data, REST compliant data, RPC data, raw data, etc.). For example, DICOM adapter 802b may be used to access DICOM data. In at least one embodiment, two or more examples of inferencing using application orchestration system 828 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 828 may distribute resources (e.g., services 720 and/or hardware 722) based on priority paths for different inferencing tasks of AI service(s) 818.

In at least one embodiment, shared storage may be mounted to AI service(s) 818 within system 800. In at least one embodiment, shared storage may operate as a cache (or other storage device type) and may be used to process inference requests from applications. In at least one embodiment, when an inference request is submitted, a request may be received by a set of API instances of deployment system 706, and one or more instances may be selected (e.g., for best fit, for load balancing, etc.) to process a request. In at least one embodiment, to process a request, a request may be entered into a database, a machine learning model may be located from model registry 724 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 812) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 720 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 826, and an inference service may perform inferencing on a GPU.

In at least one embodiment, visualization service(s) 820 may be leveraged to generate visualizations for viewing outputs of applications and/or deployment pipeline(s) 810. In at least one embodiment, GPUs/graphics 822 may be leveraged by visualization service(s) 820 to generate visualizations. In at least one embodiment, rendering effects, such as ray-tracing or other light transport simulation techniques, may be implemented by visualization service(s) 820 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 820 may include an internal visualizer, cinematics, and/or other rendering or image processing capabilities or functionality (e.g., ray tracing, rasterization, internal optics, etc.).

In at least one embodiment, hardware 722 may include GPUs/graphics 822, AI system(s) 824, cloud 826, and/or any other hardware used for executing training system 704 and/or deployment system 706. In at least one embodiment, GPUs/graphics 822 (e.g., NVIDIA's TESLA® and/or QUADRO® GPUs) may include any number of GPUs that may be used for executing processing tasks of compute service(s) 816, collaborative content creation service(s) 817, AI service(s) 818, simulation service(s) 819, visualization service(s) 820, other services, and/or any of features or functionality of software 718. For example, with respect to AI service(s) 818, GPUs/graphics 822 may be used to perform pre-processing on imaging data (or other data types used by machine learning models), post-processing on outputs of machine learning models, and/or to perform inferencing (e.g., to execute machine learning models). In at least one embodiment, cloud 826, AI system(s) 824, and/or other components of system 800 may use GPUs/graphics 822. In at least one embodiment, cloud 826 may include a GPU-optimized platform for deep learning tasks. In at least one embodiment, AI system(s) 824 may use GPUs, and cloud 826—or at least a portion tasked with deep learning or inferencing—may be executed using one or more AI system(s) s 824. As such, although hardware 722 is illustrated as discrete components, this is not intended to be limiting, and any components of hardware 722 may be combined with, or leveraged by, any other components of hardware 722.

In at least one embodiment, AI system(s) 824 may include a purpose-built computing system (e.g., a super-computer or an HPC) configured for inferencing, deep learning, machine learning, and/or other artificial intelligence tasks. In at least one embodiment, AI system(s) 824 (e.g., NVIDIA's DGX™) may include GPU-optimized software (e.g., a software stack) that may be executed using a plurality of GPUs/graphics 822, in addition to CPUs, RAM, storage, and/or other components, features, or functionality. In at least one embodiment, one or more AI system(s) s 824 may be implemented in cloud 826 (e.g., in a data center) for performing some or all of AI-based processing tasks of system 800.

In at least one embodiment, cloud 826 may include a GPU-accelerated infrastructure (e.g., NVIDIA's NGC™) that may provide a GPU-optimized platform for executing processing tasks of system 800. In at least one embodiment, cloud 826 may include an AI system(s) 824 for performing one or more of AI-based tasks of system 800 (e.g., as a hardware abstraction and scaling platform). In at least one embodiment, cloud 826 may integrate with application orchestration system 828 leveraging multiple GPUs to enable seamless scaling and load balancing between and among applications and services 720. In at least one embodiment, cloud 826 may be tasked with executing at least some of services 720 of system 800, including compute service(s) 816, AI service(s) 818, and/or visualization service(s) 820, as described herein. In at least one embodiment, cloud 826 may perform small and large batch inference (e.g., executing NVIDIA's TensorRT™), provide an accelerated parallel computing platform 830 (e.g., NVIDIA's CUDA®), execute application orchestration system 828 (e.g., KUBERNETES), provide a graphics rendering API and platform (e.g., for ray-tracing, 2D graphics, 3D graphics, and/or other rendering techniques to produce higher quality cinematics), and/or may provide other functionality for system 800. In at least one embodiment, parallel computing platform 830 may include an API.

In at least one embodiment, in an effort to preserve patient confidentiality (e.g., where patient data or records are to be used off-premises), cloud 826 may include a registry, such as a deep learning container registry. In at least one embodiment, a registry may store containers for instantiations of applications that may perform pre-processing, post-processing, or other processing tasks on patient data. In at least one embodiment, cloud 826 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Neural Network Training and Deployment

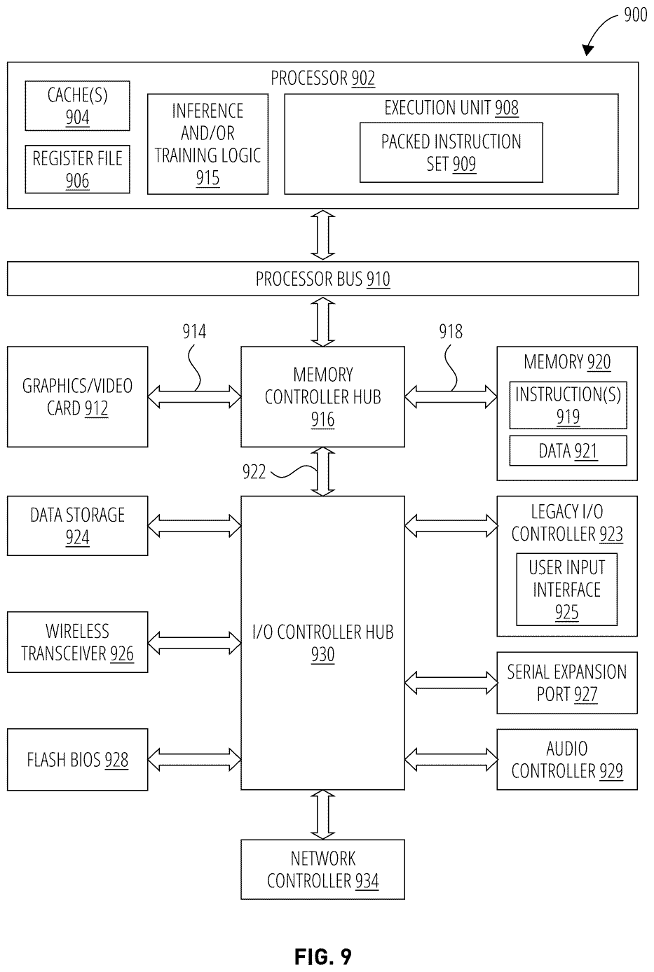

FIG. 9 is a block diagram illustrating an exemplary computer system 900, which may be a system with interconnected devices and components, a system-on-a-chip (SOC) or some combination thereof formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment, computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs.

In at least one embodiment, processor 902 may include, without limitation, a Level 2 (“L2”) internal cache memory (“cache”) 904. The L2 cache can serve as a secondary, larger, and somewhat slower cache compared to the L1 cache that is still faster than accessing the main memory (e.g., via the memory controller hub 916). Thus, the L2 cache can enhance performance by reducing the time the processor spends accessing the main memory. In at least one embodiment, processor 902 may have a single internal L2 cache or multiple levels of internal cache. In embodiments where the processor 902 is a multi-core processor, the L2 cache can be shared among multiple cores of processor 902, providing a larger, intermediate level of cache memory for more than one processing core. In at least one embodiment, L2 cache memory may reside external to processor 902.

In at least one embodiment, processor 902 may include, without limitation, a Level 3 (“L3”) internal cache memory (“cache”) 904. The L3 cache can serve as a tertiary, larger, and slower cache compared to both the L1 and L2 caches. The L3 cache can enhance performance by reducing the time the processor spends accessing the main memory. The L3 cache can be shared among multiple cores of processor 902, providing a larger pool of fast-access memory for data for the processor cores. In at least one embodiment, processor 902 may have a single internal L3 cache or multiple levels of internal cache. In at least one embodiment, L3 cache memory may reside external to processor 902. Other embodiments may also include any combination of internal or external L1, L2, and/or L3 caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934, which may include in some embodiments, a data processing unit. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 915 are used to perform inferencing and/or training operations associated with one or more embodiments. The inference and/or training logic 915 may include same or similar features of training logic/hardware structure(s) 515. Details training logic/hardware structure(s) 515 are provided in conjunction with FIG. 5A and/or FIG. 5B. In at least one embodiment, inference and/or training logic 915 may be used in system FIG. 9 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

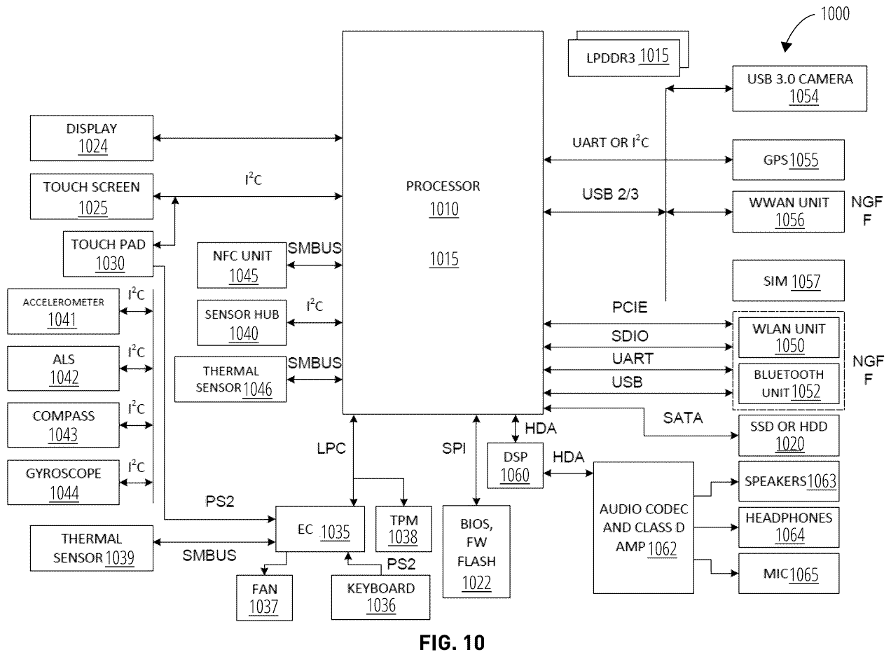

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, an edge device, an IoT device, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 12C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speaker 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic/hardware structures 515 are used to perform inferencing and/or training operations associated with one or more embodiments. Details regarding training logic/hardware structure(s) 515 are provided in conjunction with FIG. 5A and/or FIG. 5B. In at least one embodiment, inference and/or training logic structures 515 may be used in system FIG. 10 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
generating semantic data corresponding to appearance features of a subject within a first image;
generating, using one or more models and the semantic data, attribute features of the subject;
generating, using the one or more models, the semantic data, and the attribute features, an embedding; and
identifying, using the one or more models and the embedding, the subject within a second image.

2. The method of claim 1, wherein the one or more models comprises a first network trained to generate training attribute features from training semantic data associated with a second subject in an initial image using a first loss function, a second network trained to generate a training embedding using the training semantic data and the training attribute features using a second loss function different from the first loss function, and a third network trained to identify the second subject within a subsequent image using the training embedding and a third loss function different from the first and second loss functions.

3. The method of claim 2, wherein at least one of the first, second, or third loss function is a triplet loss function or a binary cross-entropy (BCE) loss function.

4. The method of claim 1, wherein a particular model of the one or more models generates the semantic data using the first image.

5. The method of claim 4, wherein the particular model is a semantic controllable self-supervised learning framework (SOLIDER), and wherein the semantic data comprises a pseudo-semantic label.

6. The method of claim 1, wherein the embedding generated by the one or more models is based at least on weights derived from relationships between the attribute features and the appearance features.

7. The method of claim 1, wherein the attribute features are indicative of at least one intrinsic attribute of the subject and at least one extrinsic attribute of the subject.

8. The method of claim 7, wherein the at least one intrinsic attribute corresponds to at least one of an age, sex, hair style, or body shape of the subject.

9. The method of claim 7, wherein the at least one extrinsic attribute corresponds to at least one of a clothing article worn by the subject or an object attached to or carried by the subject.

10. A device comprising:
one or more processors; and
a memory storing instructions that, when executed by the one or more processors, configure the device to:
obtain semantic data corresponding to appearance features of a subject within a first image;
generate, using one or more models and the semantic data, attribute features of the subject;
generate, using the one or more models, the semantic data, and the attribute features, an embedding; and
identify, using the one or more models and the embedding, the subject within a second image.

11. The device of claim 10, wherein the one or more models comprises a first network trained to generate attribute features from training semantic data associated with a second subject in an initial image using a first loss function, a second network trained to generate a training embedding using the training semantic data and the training attribute features using a second loss function different from the first loss function, and a third network trained to identify the second subject within a subsequent image using the training embedding and a third loss function different from the first and second loss functions.

12. The device of claim 11, wherein at least one of the first, second, or third loss function is a triplet loss function or a binary cross-entropy (BCE) loss function.

13. The device of claim 10, wherein a particular model of the one or more models generates the semantic data using the first image.

14. The device of claim 13, wherein the particular model is a semantic controllable self-supervised learning framework (SOLIDER), and wherein the semantic data comprises a pseudo-semantic label.

15. The device of claim 10, wherein the embedding generated by the one or more models is based at least on weights derived from relationships between the attribute features and the appearance features.

16. The device of claim 10, wherein the attribute features are indicative of at least one intrinsic attribute of the subject and at least one extrinsic attribute of the subject.

17. The device of claim 16, wherein the at least one intrinsic attribute corresponds to at least one of an age, sex, hair style, or body shape of the subject.

18. The device of claim 16, wherein the at least one extrinsic attribute corresponds to at least one of a clothing article worn by the subject or an object attached to or carried by the subject.

19. A method comprising:
determining training sets of semantic data, wherein each training set of semantic data corresponds to one of a plurality of first images that depicts one of a plurality of subjects;
training a first network using the training sets of semantic data to generate training sets of attribute features, wherein each training set of attribute features corresponds to one of the training sets of semantic data;
training a second network using the training sets of attribute features and the training sets of semantic data to generate training embeddings, wherein each training embedding corresponds to one of the training sets of attribute features and to one of the training sets of semantic data; and
training a third network using the training embeddings to identify the plurality of subject in a plurality of second images.

20. The method of claim 19, wherein during at least the training of the second network and the training of the third network, parameters of the second and third networks are jointly updated based at least on a combined loss gradient algorithm that combines a first loss gradient corresponding to the second network and a second loss gradient corresponding to the third network.
